(19) United States
(12) Patent Application Publication
(10) Pub. No.: US 2025/0035971 A1
(43) Pub. Date: Jan. 30, 2025

(54) LIQUID CRYSTAL DIMMABLE WINDOW

(71) Applicant: WICUE USA INC., Santa Clara, CA (US)

(72) Inventors: Fenghua LI, Cupertino, CA (US); Martin HAINFELLNER, Graefelfing (DE)

(73) Assignee: WICUE USA INC., Santa Clara, CA (US)

(21) Appl. No.: 18/263,342

(22) PCT Filed: Apr. 21, 2023
(86) PCT No.: PCT/US2023/019324

§ 371 Date: Jul. 27, 2023

Related U.S. Application Data
(60) Provisional application No. 63/335,144, filed on Apr. 26, 2022.

(51) Int. Cl. G02F 1/1333; B60J 3/04

(52) U.S. Cl. CPC G02F 1/133311; B60J 3/04; G02F 1/133302

(57) ABSTRACT

An apparatus having a multi-layer structure for providing a dimmable window operation is provided. The apparatus includes a first rigid substrate; a second rigid substrate coupled to the first rigid substrate at a perimeter region of the multi-layer structure, to maintain a separation between the first rigid substrate and the second rigid substrate; and a liquid crystal (LC) film positioned within the separation between the first rigid substrate and the second rigid substrate. The LC film is coupled to either the first rigid substrate or the second rigid substrate at an inner region of the multi-layer structure to define a gap between the LC film and another one of the first rigid substrate and the second rigid substrate. The gap is not occupied by a solid material or a liquid material.

### TECHNICAL FIELD

Aspects of the disclosure relate to windows and more specifically to dimmable windows.

### BACKGROUND

Dimmable windows have the potential for providing adjustable tinting, e.g., to adapt to environmental conditions and/or user preference. Existing dimmable windows typically utilize electrochromic glass, which is based on what is known as a redox chemical reaction in certain types of materials, such as various metal oxides, to change the optical color or opacity of the material in response to the application of an electrical field. However, electrochromic glass and other solutions that rely on electrochromism typically suffer slow response times associated with the redox chemical reaction. Typical response times can be on the order of several minutes or more than ten minutes. Such slow response times can be inconvenient and frustrating to a user, especially in circumstances where unwanted light suddenly appears and changes to shading or tinting are needed quickly. Use cases such as vehicular windows are particularly problematic. Unlike a building, a vehicle can quickly change its position and orientation. For example, a vehicular window that is not exposed to sun light in one moment can suddenly become exposed to strong sun light in the very next moment, e.g., when the vehicle makes a turn or exits a shadow cast by a tall building or other structure. The vehicular window can just as quickly become not exposed to sunlight again when the vehicle makes another change in its position and/or orientation. An electrochromic window, with its slow response time, simply cannot keep up with such quick transitions and the need to adjust tinting levels dynamically. However, specific challenges exist for other types of dimmable window technology especially given certain application-specific demands. There is thus a need for improved dimmable windows, especially in applications where quick response time dynamic adjustment is desired.

### SUMMARY

An apparatus having a multi-layer structure for providing a dimmable window operation is provided. The apparatus includes a first rigid substrate; a second rigid substrate coupled to the first rigid substrate at a perimeter region of the multi-layer structure, to maintain a separation between the first rigid substrate and the second rigid substrate; and a liquid crystal (LC) film positioned within the separation between the first rigid substrate and the second rigid substrate, wherein the LC film is coupled to either the first rigid substrate or the second rigid substrate at an inner region of the multi-layer structure to define a gap between the LC film and another one of the first rigid substrate and the second rigid substrate, and wherein the gap is not occupied by a solid material or a liquid material.

In some embodiments, the LC film is coupled to the first rigid substrate at the inner region of the multi-layer structure, and the gap is defined between the LC film and the second rigid substrate; or the LC film is coupled to the second rigid substrate at the inner region of the multi-layer structure, and the gap is defined between the LC film and the first rigid substrate.

In some embodiments, the first rigid substrate defines a convex exterior surface of the multi-layer structure, and the second rigid substrate defines a concave interior surface of the multi-layer structure.

In some embodiments, the gap is characterized by a separation distance ranges from 0.1 millimeter to 4 millimeters.

In some embodiments, the gap is configured to maintain a vacuum.

In some embodiments, the gap is filled with at least one gas, and the at least one gas comprises argon gas, or an air mixture including nitrogen gas and oxygen gas.

In some embodiments, the apparatus includes a perimeter support member positioned at the perimeter region of the multi-layer structure and configured to couple the first rigid substrate to the second rigid substrate; wherein the first rigid substrate, the second rigid substrate, and the perimeter support member are configured to maintain airtightness of the separation between the first rigid substrate and the second rigid substrate.

In some embodiments, the first rigid substrate comprises a first glass layer, a second glass layer, and a laminate layer between the first glass layer and the second glass layer.

In some embodiments, the laminate layer comprises a polyvinyl butyral (PVB) material.

In some embodiments, the first rigid substrate comprises a tempered glass layer.

In some embodiments, the second rigid substrate comprises a non-glass layer, wherein the non-glass layer comprises a polycarbonate (PC) material.

In some embodiments, the multi-layer structure is configured for installation in a vehicle, the first rigid substrate is configured to face an exterior environment of the vehicle, and the second rigid substrate is configured to face an interior environment of the vehicle.

In some embodiments, the multi-layer structure is configured as a sunroof, a side window, a rear windshield, or a front windshield of the vehicle.

Another apparatus having a multi-layer structure for providing a dimmable window operation is provided. The apparatus includes a first rigid substrate; a second rigid substrate coupled to the first rigid substrate at a perimeter region of the multi-layer structure, to maintain a separation between the first rigid substrate and the second rigid substrate; a liquid crystal (LC) film positioned within the separation between the first rigid substrate and the second rigid substrate; and a laminate layer positioned between the LC film and the first rigid substrate. The LC film spans an inner region of the multi-layer structure and is coupled to the second rigid substrate at the inner region of the multi-layer structure. The LC film interfaces with the laminate layer at the inner region of the multi-layer structure. The laminate layer interfaces with the first rigid substrate at both the inner region of the multi-layer structure and the perimeter region of the multi-layer structure. The laminate layer interfaces with the second rigid substrate at the perimeter region of the multi-layer structure.

In some embodiments, the laminate layer comprises a solid material or a liquid material.

In some embodiments, the laminate layer comprises a polyvinyl butyral (PVB) material.

In some embodiments, the LC film is coupled, by an optically clear adhesive (OCA) film, to the second rigid substrate at the inner region of the multi-layer structure.

In some embodiments, the second rigid substrate comprises a non-glass layer.

In some embodiments, the non-glass layer comprises a polycarbonate (PC) material.

In some embodiments, the first rigid substrate defines a convex exterior surface of the multi-layer structure. The second rigid substrate defines a concave interior surface of the multi-layer structure.

### BRIEF DESCRIPTION OF THE DRAWINGS

FIG. 1 illustrates a simplified diagram of a vehicle employing a multi-layer structure providing a dimmable window operation for one or more windows, according to embodiments of the disclosure.

FIG. 2 is a cross-sectional view of a multi-layer structure 200 providing a dimmable window operation.

FIG. 3 is a cross-sectional view of a multi-layer structure 300 providing a dimmable window operation.

FIG. 4 is a cross-sectional view of a multi-layer structure 400 providing a dimmable window operation

FIG. 5 is a cross-sectional view of a multi-layer structure 500 providing a dimmable window operation.

FIG. 6 is a cross-sectional view of a multi-layer structure 600 providing a dimmable window operation.

FIG. 7 is a top-down view of a multi-layer structure 700 providing a dimmable window operation.

FIG. 8 is a cross-sectional view of a multi-layer structure 800 providing a dimmable window operation.

FIG. 9 is a top-down view of a multi-layer structure 900 providing a dimmable window operation.

FIG. 10A is a simplified example intended to illustrate components that are typical of an LC film described herein with respect to other embodiments.

FIG. 10B illustrates an example configuration of a liquid crystal to provide adjustable light transmittance.

FIG. 10C illustrates another example configuration of a liquid crystal to provide adjustable light transmittance.

### DETAILED DESCRIPTION OF THE EMBODIMENTS

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

FIG. 1 illustrates a simplified diagram of a vehicle 100 employing a multi-layer structure providing a dimmable window operation for one or more windows, according to embodiments of the disclosure. The diagram merely shows one example of an environment on which dimmable windows may be installed. As shown, vehicle 100 has different types of windows, including a sunroof 102, a side window 104, a rear windshield 106, and a front windshield 108. Multi-layer structures implemented as dimmable windows according to embodiments of the present disclosure may be implemented in one or more of the windows on vehicle 100, including the sunroof 102, the side window 104, the rear windshield 106, and/or the front windshield 108.

In an embodiment, a layered structure according to an aspect of the disclosure is configured as a sunroof 102. Generally speaking, governmental safety regulations that prohibit or limit the degree of tinting in automobiles typically do not apply to sunroofs. Also, sunlight near or around midday, when sun rays are the strongest, can affect sunroofs more than other types of windows. As such, dimming windows according to aspects of the disclosure, with their benefit to controllably block out or lessen the effects of sun rays, may have particularly high levels of installation as sunroofs.

In another embodiment, a layered structure according to an aspect of the disclosure is configured as a side window 104. Some governmental safety regulations may exist regarding tinting for side windows in automobiles. Often, such regulations do not prohibit tinting but merely limit the degree of tinting for side windows. Here, a dimmable window according to embodiments of the present disclosure may serve to provide protection from sun rays and/or provide privacy for occupants of the vehicle 100. The ability to control the degree of tinting also makes conformance to governmental safety regulations regarding specific degrees of tinting more easily achieved.

In yet other embodiments, a layered structure according to an aspect of the disclosure is configured as a rear windshield 106 or a front windshield 108. Many governmental safety regulations currently prohibit tinting for front windshields or rear windshields in automobiles. Highly controllable dimmable windows according to aspects of the present disclosure may provide a degree of slight tinting that is acceptable under certain governmental safety regulations.

As shown, some or all of the windows in vehicle 100 are curved.

According to various embodiments of the disclosure, a multi-layer structure used as a dimmable window may have a curve surface—i.e., non-flat surface. Here, the description of a curved surface refers to the fact that the multi-layer structure may have one or two outer surfaces having a shape that is curved, as opposed to flat. Such a curved surface may be curved along one dimension or two dimensions. In the case of curvature along only one dimension, the curved surface may (1) intersect with a first plane along a curved line but (2) intersect with a second plane (e.g., perpendicular to the first plane) along a straight line. A non-limiting example of a one-dimensionally curved surface is a parabolic cylinder surface (e.g., z=x2) defined along an x-y-z cartesian coordinate system. In the case of curvature along two dimensions, the curved surface may (1) intersect with a first plane along a first curved line and (2) intersect with a second plane (e.g., perpendicular to the first plane) along a second curved line. A non-limiting example of a two-dimensionally curved surface is an elliptic paraboloid surface (e.g., z=x2+y2) defined along an x-y-z cartesian coordinate system. The mathematically-defined curves described above (e.g., parabolic cylinder, elliptic paraboloid, etc.) are merely provided for purposes of illustrating examples of surfaces curved along one and two dimensions, respectively. Not all curved surfaces according to aspects of the present disclosure are necessarily defined mathematically. For instance, the particular shape of a one-dimensionally curved or two-dimensionally curved dimmable window used in a vehicle may depend on the design of the vehicle and not be dictated by a simple mathematical formula.

While FIG. 1 illustrates a vehicle in the form of an automobile as an example environment, structures described as embodiments of the present disclosure, such as a multi-layer structure used as a dimmable window, may be employed in other environments, such as in buildings and other non-vehicular applications. Also, vehicular applications are not limited to the particular type of vehicle shown in FIG. 1, which is presented only as an example. For instance, a multi-layer structure according to various aspects of the disclosure may be employed in tracked vehicle (e.g., trains) and airborne vehicles (e.g., airplanes, air taxis, etc.), just to name some examples.

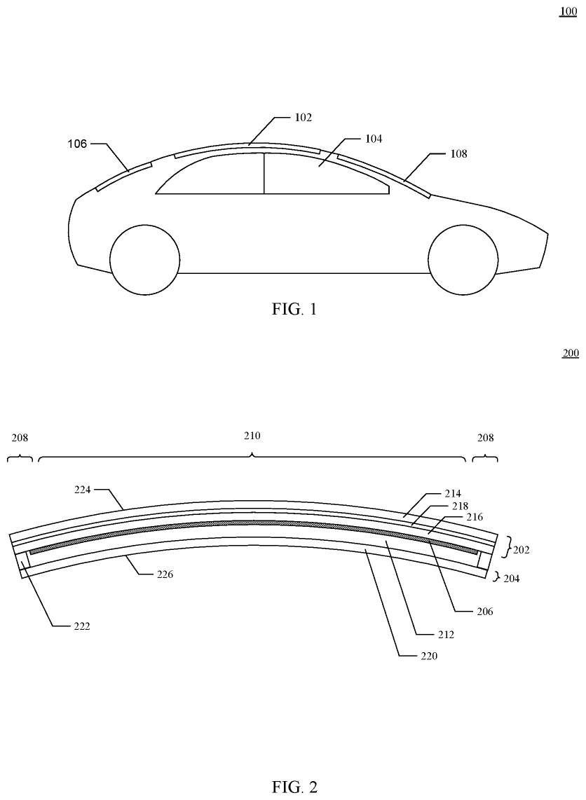

FIG. 2 is a cross-sectional view of a multi-layer structure 200 providing a dimmable window operation with a first rigid substrate 202, a second rigid substrate 204, and a liquid crystal film 206 according to certain embodiments of the disclosure, wherein a separation is defined between the first rigid substrate 202 and the second rigid substrate 204, the liquid crystal film 206 is bonded to the first rigid substrate 202. In some embodiments, an apparatus having a multi-layer structure 200 for providing a dimmable window operation is disclosed. The apparatus comprises a first rigid substrate 202, a second rigid substrate 204 and a liquid crystal (LC) film 206, wherein the second rigid substrate 204 is coupled to the first rigid substrate 202 at a perimeter region 208 of the multi-layer structure 200 to maintain a separation between the first rigid substrate 202 and the second rigid substrate 204, the LC film 206 is positioned within the separation between the first rigid substrate 202 and the second rigid substrate 204.

The LC film 206 is coupled to either the first rigid substrate 202 or the second rigid substrate 204 at an inner region 210 of the multi-layer structure 200. In the particular example shown in FIG. 2, the LC film 206 is coupled to the first rigid substrate 202 at the inner region 210 and not coupled to the second rigid substrate 204 at the inner region 210 of the multi-layer structure 200. Here, one layer may be coupled to another layer by bonding, such as through an adhesive, which may be in the form of an adhesive liquid, gel, or solid (e.g., adhesive film). In an embodiment, the LC film 206 may be bonded to the first rigid substrate 202 by an optically clear adhesive (OCA) positioned between the LC film 206 and the first rigid substrate 202.

Since the LC film 206 is coupled to either the first rigid substrate 202 or the second rigid substrate 204 and is separated from the other one of the first rigid substrate 202 and the second rigid substrate 204, a gap 212 is defined between the LC film 206 and the other one of the first rigid substrate 202 and the second rigid substrate 204 at the inner region 210 of the multi-layer structure 200. In the particular example shown in FIG. 2, the LC film 206 is separated from the second rigid substrate 204 at the inner region 210 of the multi-layer structure 200, to define the gap 210 between the LC film 206 and the second rigid structure 204. In some aspects of the disclosure, the gap 212 is characterized by a separation distance ranging from 0.1 millimeter to 4 millimeters. That is, the distance separating the LC film 206 from the second rigid substrate 204 may have an average value within the range from 0.1 millimeter to 4 millimeters. In an embodiment, this separation distance is consistently maintained throughout the inner region 210. In other embodiments, the separation distance is characterized by some variations at different location within the inner region 210, but the average value of the separation distance falls in the range from 0.1 millimeter to 4 millimeters.

According to various embodiments of the disclosure, the gap 212 between the LC film 206 and the other one of the first rigid substrate 202 and the second rigid substrate 204 is not occupied by a solid material or a liquid material. In the example shown, the gap 212 between the LC film 206 and the second rigid structure 204 is not occupied by a solid material or a liquid material. Instead, the gap 212 may be occupied by a gaseous material or not be occupied by any material at all. In an embodiment, the gap 212 is configured to maintain a vacuum. In another embodiment, the gap 212 comprises argon gas. In yet another embodiment, the gap 212 comprises an air mixture including nitrogen gas and oxygen gas.

The gap 212 may serve to provide thermal isolation between the first rigid substrate 202 and the second rigid substrate 204. In some applications, the multi-layer structure 200 is configured for installation in, for example, a vehicle (e.g., vehicle 100). The first rigid substrate 202 may face an exterior environment (e.g., exterior of vehicle 100), and the second rigid substrate may face an interior environment (e.g., interior of vehicle 100). In a scenario in which the first rigid substrate 202 is exposed to direct sunlight over an extended period of time (e.g., in a sunroof application), the first rigid substrate 202 may heat up to an exceedingly high temperature. The gap 212 may provide thermal isolation to keep the second rigid substrate 204 from heating up along with the first rigid substrate 202. By employing the gap 212 with vacuum or air, the second rigid substrate 202 may be kept at a significantly lower temperature than the first rigid substrate 204, thereby minimizing the risk of potential discomfort or even burns suffered by occupants who might accidentally touch the second rigid substrate 204 from the interior environment.

Each of the first rigid substrate 202 and the second rigid substrate 204 may comprise one or more layers. In the example shown in FIG. 2, the first rigid substrate 202 comprises three layers: (1) a first glass layer 214, (2) a second glass layer 216, and (3) a laminate layer 218 between the first glass layer 214 and the second glass layer 216. In some embodiments, the laminate layer 218 may comprise a polyvinyl butyral (PVB) material. Here, the PVB laminate layer 218 may serve to provide a shatter-proof function to strengthen the multiple layers of the first rigid substrate 204 and hold together shards of glass in the event that one or both of the first glass layer 214 and the second glass layer 216 are shattered. In the example shown in FIG. 2, the second rigid substrate 204 comprises only a third glass layer 220. The third glass layer 220 serves as an interior-facing surface that is relatively scratch-resistant and easy to clean of dirt and smudges. The third glass layer 220 is also strong enough to maintain the gap 212, even when the gap 212 is characterized by negative pressure (e.g., a vacuum) or positive pressure (e.g., occupied by a pressurized gas). In FIG. 2 and subsequent figures, an LC film such as the LC film 206 may comprise multiple layers.

As shown in the cross-sectional view of FIG. 2, the multi-layer structure 200 may have a curved surface. In the example shown, the first rigid substrate 202 may face an exterior environment of a vehicle (e.g., vehicle 100), and the second rigid substrate 204 may face an interior environment of the vehicle. Here, the first rigid substrate 202 may define a convex exterior surface 224 of the multi-layer structure 200, and the second rigid substrate 204 may define a concave interior surface 226 of the multi-layer structure 200. The convex exterior surface 224 defined by the first rigid substrate 202 may be a surface that is convexly curved along two dimensions (e.g., x and y dimensions). The concave interior surface 226 defined by the second rigid substrate 204 may be a surface that is concavely curved along two dimensions (e.g., x and y dimensions).

The multi-layer structure 200 may further comprise a perimeter support member 222 positioned at the perimeter region 208 and configured to couple the first rigid substrate 202 to the second rigid substrate 204. The perimeter support member 222 may serve to maintain the separation between the first rigid substrate 202 and the second rigid substrate 204. One or more adhesives may be used to bond the perimeter support member 222 to the first rigid substrate 202 and the second rigid substrate 204. For example, a first adhesive may be used to bond the first rigid substrate 202 to the perimeter support member 222 in the perimeter region 208. A second adhesive may be used to bond the perimeter support member 222 to the second rigid substrate 204 in the perimeter region 208. The first rigid substrate 202, the second rigid substrate 204, and the perimeter support member 222 may be configured to maintain airtightness of the separation between the first rigid substrate 202 and the second rigid substrate 204, thus ensuring that the desired vacuum or gas content of the gap 212 is properly preserved.

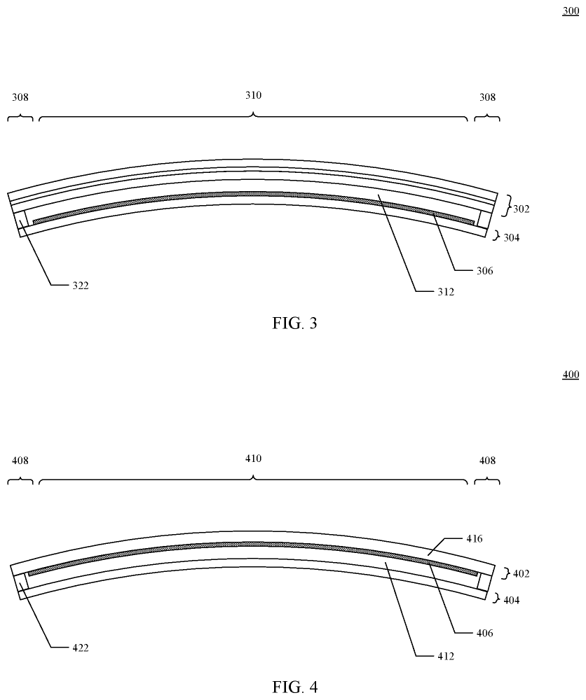

FIG. 3 is a cross-sectional view of a multi-layer structure 300 providing a dimmable window operation with a first rigid substrate 302, a second rigid substrate 304, and a liquid crystal film 306 according to certain embodiments of the disclosure, wherein a separation is defined between the first rigid substrate 302 and the second rigid substrate 304, the liquid crystal film 306 is bonded to the second rigid substrate 304. In some embodiments, an apparatus having a multi-layer structure 300 for providing a dimmable window operation is disclosed. The multi-layer structure 300 is similar to the multi-layer structure 200 shown in FIG. 2 in certain respects. The multi-layer structure 300 comprises a first rigid substrate 302 with a multi-layer structure, a second rigid substrate 304 and a liquid crystal (LC) film 306, wherein the second rigid substrate 304 is coupled to the first rigid substrate 302 at a perimeter region 308 of the multi-layer structure 300 to maintain a separation between the first rigid substrate 302 and the second rigid substrate 304, the LC film 306 is positioned within the separation between the first rigid substrate 302 and the second rigid substrate 304. The LC film 306 is coupled to either the first rigid substrate 302 or the second rigid substrate 304 at an inner region 308 of the multi-layer structure 300 at the inner region 310 of the multi-layer structure 300.

However, in the particular example shown in FIG. 3, the LC film 306 is coupled to the second rigid substrate 304 at the inner region 310 and not coupled to the first rigid substrate 302 at the inner region 310 of the multi-layer structure 300. Once again, one layer may be coupled to another layer by bonding. In an embodiment, the LC film 306 may be bonded to the second rigid substrate 304 by an optically clear adhesive (OCA) positioned between the LC film 306 and the second rigid substrate 304.

Since the LC film 306 is coupled to either the first rigid substrate 302 or the second rigid substrate 304 and is separated from the other one of the first rigid substrate 302 and the second rigid substrate 304, a gap 312 is defined between the LC film 306 and the other one of the first rigid substrate 302 and the second rigid substrate 304. In the particular example shown in FIG. 3, the LC film 306 is separated from the first rigid substrate 302 at the inner region 310 of the multi-layer structure 300, to define the gap 310 between the LC film 306 and the first rigid structure 302. In some aspects of the disclosure, the gap 312 is characterized by a separation distance ranging from 0.1 millimeter to 4 millimeters. In an embodiment, this separation distance is consistently maintained throughout the inner region. In other embodiments, the separation distance is characterized by some variations at different location within the inner region, but the average value of the separation distance falls in the range from 0.1 millimeter to 4 millimeters.

According to various embodiments of the disclosure, the gap 312 between the LC film 306 and the first rigid structure 302 is not occupied by a solid material or a liquid material. Instead, the gap 312 may be occupied by a gaseous material or not be occupied by any material at all. In an embodiment, the gap 312 is configured to maintain a vacuum. In another embodiment, the gap 312 comprises argon gas. In yet another embodiment, the gap 312 comprises an air mixture including nitrogen gas and oxygen gas. The gap 312 may serve to provide thermal isolation between the first rigid substrate 302 and the second rigid substrate 304. Also, each of the first rigid substrate 302 and the second rigid substrate 304 may comprise one or more layers. In the example shown in FIG. 3, the first rigid substrate 302 comprises three layers: (1) a first glass layer, (2) a second glass layer, and (3) a laminate layer between the first glass layer and the second glass layer. In some embodiments, the laminate layer may comprise a polyvinyl butyral (PVB) material. In the example shown in FIG. 3, the second rigid substrate 304 comprises only a third glass layer 320. The third glass layer 320 serves as an interior-facing surface that is relatively scratch-resistant and easy to clean of dirt and smudges. The third glass layer 320 is also strong enough to maintain the gap 312, even when the gap 312 is characterized by negative pressure or positive pressure. The multi-layer structure 300 may have a curved surface. In an example, a convex exterior surface defined by the first rigid substrate 302 may be a surface that is convexly curved along two dimensions (e.g., x and y dimensions). A concave interior surface defined by the second rigid substrate 304 may be a surface that is concavely curved along two dimensions (e.g., x and y dimensions).

Again the multi-layer structure 300 may further comprise a perimeter support member 322 positioned at the perimeter region 308 and configured to couple the first rigid substrate 302 to the second rigid substrate 304. The perimeter support member 322 may serve to maintain the separation between the first rigid substrate 302 and the second rigid substrate 304. One or more adhesives may be used to bond the perimeter support member 322 to the first rigid substrate 302 and the second rigid substrate 304. The first rigid substrate 302, the second rigid substrate 304 and the perimeter support member 322 maintain airtightness of the separation between the first rigid substrate 302 and the second rigid substrate 304.

FIG. 4 is a cross-sectional view of a multi-layer structure 400 providing a dimmable window operation with a first rigid substrate 402 and a second rigid substrate 404 according to certain embodiments of the disclosure, wherein a separation is defined between first rigid substrate 402 and the second rigid substrate 404, and a tempered glass layer serves as the first rigid substrate 402. In some embodiments, an apparatus having a multi-layer structure 400 for providing a dimmable window operation is disclosed. The multi-layer structure 400 is similar to the multi-layer structure 200 shown in FIG. 2 in certain respects. The multi-layer structure 400 comprises a first rigid substrate 402, a second rigid substrate 404 and a liquid crystal (LC) film 406, wherein the second rigid substrate 404 is coupled to the first rigid substrate 402 at a perimeter region 408 of the multi-layer structure 400 to maintain a separation between the first rigid substrate 402 and the second rigid substrate 404, and the LC film 406 is positioned within the separation between the first rigid substrate 402 and the second rigid substrate 404. The LC film 406 is coupled to either the first rigid substrate 402 or the second rigid substrate 404 at an inner region 408 of the multi-layer structure 400.

However, in the particular example shown in FIG. 4, the first rigid substrate 402 comprises a single layer, which in this example is a tempered glass layer 416. The tempered glass layer 416 may be lighter in weight compared to a sandwich structure for the first rigid substrate comprising a first glass layer, a second glass layer, and a laminate layer, such as that of the first rigid substrate 202 shown in FIG. 2. The lighter weight of the tempered glass layer 416 may be a significant benefit in certain applications, especially when weight considerations are prioritized. The added strength of tempered glass as a material, as contrasted with non-tempered glass, provides a degree of shatter resistance and can be used in lieu of the sandwich construction of the first rigid substrate 202, under appropriate circumstances.

In other respects, the multi-layer structure 400 may be similar to the multi-layer structure 200 shown in FIG. 2. For example, the LC film 406 may be bonded to the first rigid substrate 402 by an optically clear adhesive (OCA) positioned between the LC film 406 and the first rigid substrate 402. The LC film 406 is separated from the second rigid substrate 404 at the inner region 410 of the multi-layer structure 400 to define a gap 412 between the LC film 406 and the second rigid substrate 404. In an embodiment, this separation distance is consistently maintained throughout the inner region. In other embodiments, the separation distance is characterized by some variations at different location within the inner region, but the average value of the separation distance falls in the range from 0.1 millimeter to 4 millimeters. According to various embodiments of the disclosure, the gap 412 between the LC film 406 and the second rigid structure 404 is not occupied by a solid material or a liquid material. Instead, the gap 412 may be occupied by a gaseous material or not be occupied by any material at all (e.g., a vacuum). The multi-layer structure 400 may have a curved surface. In an example, a convex exterior surface defined by the first rigid substrate 402 may be a surface that is convexly curved along two dimensions (e.g., x and y dimensions). A concave interior surface defined by the second rigid substrate 404 may be a surface that is concavely curved along two dimensions (e.g., x and y dimensions). Again the multi-layer structure 400 may further comprise a perimeter support member 422 positioned at the perimeter region 408 and configured to couple the first rigid substrate 402 to the second rigid substrate 404. The perimeter support member 422 may serve to maintain the separation between the first rigid substrate 402 and the second rigid substrate 404. One or more adhesives may be used to bond the perimeter support member 422 to the first rigid substrate 402 and the second rigid substrate 404. The first rigid substrate 402, the second rigid substrate 404 and the perimeter support member 422 maintain airtightness of the separation between the first rigid substrate 402 and the second rigid substrate 404.

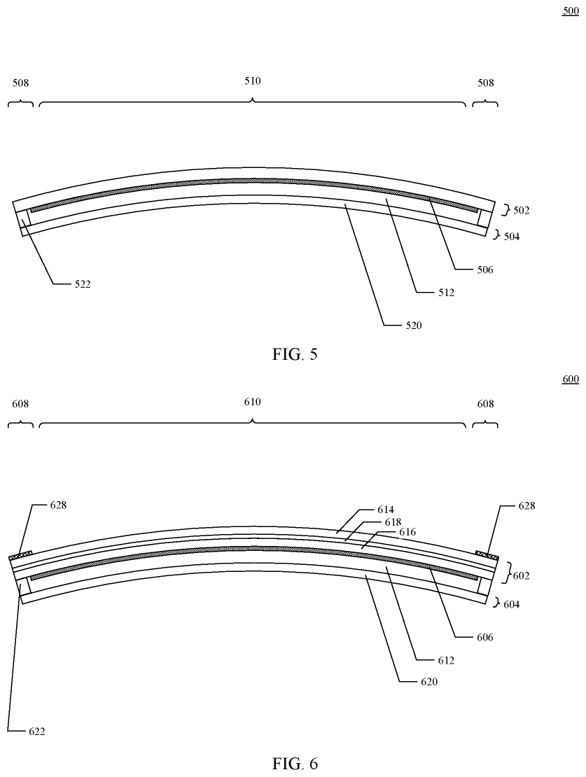

FIG. 5 is a cross-sectional view of a multi-layer structure 500 providing a dimmable window operation with a first rigid substrate 502 and a second rigid substrate 504 according to certain embodiments of the disclosure, wherein a separation is defined between the first rigid substrate 502 and the second rigid substrate 504, and a polycarbonate layer serves as the second rigid substrate 504. In some embodiments, an apparatus having a multi-layer structure 500 for providing a dimmable window operation is disclosed. The multi-layer structure 500 is similar in certain respects to the multi-layer structure 200 shown in FIG. 2 or the multi-layer structure 400 shown in FIG. 4. The multi-layer structure 500 comprises a first rigid substrate 502, a second rigid substrate 504 and a liquid crystal (LC) film 506, wherein the second rigid substrate 504 is coupled to the first rigid substrate 502 at a perimeter region 508 of the multi-layer structure 500 to maintain a separation between the first rigid substrate 502 and the second rigid substrate 504, and the LC film 506 is positioned within the separation between the first rigid substrate 502 and the second rigid substrate 504. The LC film 506 is coupled to either the first rigid substrate 502 or the second rigid substrate 504 at an inner region 508 of the multi-layer structure 500.

However, in the particular example shown in FIG. 5, the second rigid substrate 504 comprises a non-glass layer 520. According to an embodiment, the non-glass layer 520 comprises a polycarbonate (PC) material. In other respects, the multi-layer structure 500 may be similar to the multi-layer structure 200 shown in FIG. 2 or the multi-layer structure 400 shown in FIG. 4. For example, the LC film 506 may be bonded to the first rigid substrate 502 by an optically clear adhesive (OCA) positioned between the LC film 506 and the first rigid substrate 502. The LC film 506 is separated from the second rigid substrate 504 at the inner region 510 of the multi-layer structure 500, to define a gap 512 between the LC film 506 and the second rigid substrate 504. According to various embodiments of the disclosure, the gap 512 between the LC film 506 and the second rigid structure 504 is not occupied by a solid material or a liquid material. The multi-layer structure 500 may have a curved surface. The multi-layer structure 500 may further comprise a perimeter support member 522 positioned at the perimeter region 508 and configured to couple the first rigid substrate 502 to the second rigid substrate 504. The perimeter support member 522 may serve to maintain the separation between the first rigid substrate 502 and the second rigid substrate 504. In other respects, the multi-layer structure 500 may be similar to the multi-layer structure 200 shown in FIG. 2 or the multi-layer structure 400 shown in FIG. 4.

FIG. 6 is a cross-sectional view of a multi-layer structure 600 providing a dimmable window operation with a first rigid substrate 602, a second rigid substrate 604, and a cladding 628 according to certain embodiments of the disclosure, wherein a separation is defined between the first rigid substrate 602 and the second rigid substrate 604, and the cladding 628 is attached to a perimeter region. In this example, a multi-layer structure 600 is presented similar in certain respects to the multi-layer structure 200 shown in FIG. 2. The multi-layer structure 600 comprises a first rigid substrate 602 with a multi-layer structure, a second rigid substrate 604 coupled to the first rigid substrate 602 at a perimeter region 608 of the multi-layer structure 500 to maintain a separation between the first rigid substrate 602 and the second rigid substrate 604, and a liquid crystal (LC) film 606 positioned within the separation between the first rigid substrate 602 and the second rigid substrate 604. The LC film 606 is coupled to either the first rigid substrate 602 or the second rigid substrate 604 at an inner region 610 of the multi-layer structure 600. The LC film 606 is separated from the second rigid substrate 604 at the inner region 610 of the multi-layer structure 600, to define a gap 612 between the LC film 606 and the second rigid substrate 604. In the example shown in FIG. 6, the first rigid substrate 602 comprises three layers: (1) a first glass layer 614, (2) a second glass layer 616, and (3) a laminate layer 618 between the first glass layer 614 and the second glass layer 616. The second rigid substrate 604 comprises only a third glass layer 620. The multi-layer structure 600 may further comprise a perimeter support member 622 positioned at the perimeter region 608 and configured to couple the first rigid substrate 602 to the second rigid substrate 604.

In addition, the multi-layer structure 600 further comprises a cladding 628 positioned at the perimeter region 608 of the multi-layer structure 600. In this example, the cladding 628 is bonded to the top surface of the first rigid substrate 602. The cladding 628 may serve as an optical shield, to hide the details of the various components at the perimeter region 608 of the multi-layer structure 600. Such details hidden by the cladding 628 may include: (1) circuits, electrodes, and/or wiring for providing control signals to the LC film 606, (2) the perimeter support member 622, (3) an outer perimeter of the LC film 606, which may be within an outer perimeter of the first rigid substrate 602 and the second rigid substrate 604, and/or (4) other components or features that might otherwise be visible near the perimeter region 608 of the multi-layer structure 600. The cladding 628 may serve as a border that hides such details and provide a clean look for the multi-layer structure 600, particularly from the perspective of an observer viewing the multi-layer structure 600 from an exterior environment (e.g., from above in FIG. 6).

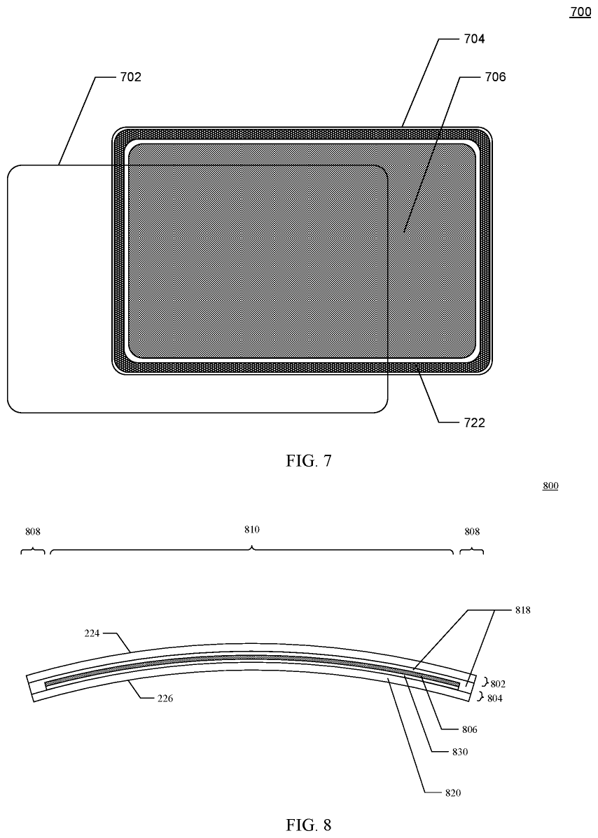

FIG. 7 is a top-down view of a multi-layer structure 700 providing a dimmable window operation according to certain embodiments of the disclosure. The multi-layer structure 700 may be an example of any one or more of the multi-layer structures 200, 300, 400, 500, or 600 described in FIG. 2, 3, 4, 5, or 6, respectively. As shown, a multi-layer structure 700 comprises a first rigid substrate 702, a second rigid substrate 704, and a liquid crystal (LC) film 706 positioned between the first rigid substrate 702 and the second rigid substrate 704. The LC film 706 may be coupled to the first rigid substrate 702 and not coupled to the second rigid substrate 704 (e.g., multi-layer structures 200, 400, 500, and 600 in FIG. 2, 4, 5, or 6, respectively). Alternatively, the LC film 706 may be coupled to the second rigid substrate 704 and not coupled to the first rigid substrate 702 (e.g., multi-layer structure 300 in FIG. 3).

Notably, according to certain embodiments, the LC film 706 has a smaller coverage area than either the first rigid substrate 702 or the second rigid substrate 704. Thus, the LC film 706 only spans the inner region of the multi-layer structure 700. By contrast, the first rigid substrate 702 spans both the inner region and the perimeter region of the multi-layer structure 700. Similarly, the second rigid substrate 704 may span both the inner region and the perimeter region of the multi-layer structure 700. By sizing the LC film 706 according to a smaller coverage area and positioning the LC film 706 to coincide with the inner region of the multi-layer structure 700, a perimeter region of the multi-layer structure 700 may be realized that provides an area where the first rigid substrate 702 and the second rigid substrate 704 may be coupled together without interfering with and potentially damaging the LC film 706. As shown in FIG. 7, a perimeter support member 722 is positioned in this perimeter region to facilitate the coupling of the first rigid substrate 702 and the second rigid substrate 704.

Appropriate adhesive(s) may be used to bond various layers shown in FIG. 7. For example, in the inner region of the multi-layer structure 700, a layer of optically clear adhesive (OCA) or OCA film (not shown) may be used to bond the LC film 706 to the second rigid substrate 704. In the perimeter region of the multi-layer structure 700, a layer of optically clear or non-optically clear adhesive or adhesive film may be used to bond the perimeter support member 722 to the second rigid substrate 704. In the perimeter region of the multi-layer structure 700, another layer of optically clear or non-optically clear adhesive or adhesive film may be used to bond the first rigid substrate 702 to the perimeter support member 722. The perimeter support member 722 serves to maintain a separation between the first rigid substrate 702 and the second rigid substrate 704, thereby defining a gap, e.g., between the LC film 706 and the first rigid substrate 704. While the top-down view of FIG. 7 does not explicitly show a cross-sectional curvature, it should be understood that the multi-layer structure 700 may have a curved surface in some embodiments.

FIG. 8 is a cross-sectional view of a multi-layer structure 800 providing a dimmable window operation with a first rigid substrate 802, a second rigid substrate 804, and a laminate layer 818 between the first rigid substrate 802 and the second rigid substrate 804, according to certain embodiments of the disclosure. In some embodiments, an apparatus having a multi-layer structure 800 is disclosed. The apparatus comprises a first rigid substrate 802, a second rigid substrate 804 and a liquid crystal (LC) film 806, wherein the second rigid substrate 804 is coupled to the first rigid substrate 802 at a perimeter region 808 of the multi-layer structure 800 to maintain a separation between the first rigid substrate 802 and the second rigid substrate 804, and the LC film 806 is positioned within the separation between the first rigid substrate 802 and the second rigid substrate 804. The first rigid substrate 802 may define a convex exterior surface of the multi-layer structure 800, and the second rigid substrate 804 may define a concave interior surface of the multi-layer structure 800.

A laminate layer 818 is positioned between the LC film 806 and the first rigid substrate 802. The LC film 806 spans an inner region 810 of the multi-layer structure 800 and is coupled to the second rigid substrate 804 at the inner region 810 of the multi-layer structure 800. The LC film 806 interfaces with the laminate layer 818 at the inner region 810 of the multi-layer structure 800. The laminate layer 818 interfaces with the first rigid substrate 802 at both the inner region 810 of the multi-layer structure 800 and the perimeter region 808 of the multi-layer structure 800. The laminate layer 818 interfaces with the second rigid substrate 804 at the perimeter region 808 of the multi-layer structure 800. As shown in the cross-sectional view presented in FIG. 8, the perimeter region 808 circumscribes the inner region 810 of the multi-layer structure 800.

Here, the second rigid substrate 804 comprises a non-glass layer 820. According to some embodiments, the non-glass layer 820 comprises a thermoplastic polymer such as polycarbonate. In the typical operating range, e.g., for vehicular window applications, an appropriate thickness of a material such as polycarbonate remains rigid as a solid and provides substantial thermal isolation. Thus, the second rigid substrate 804, when implemented as a thermoplastic polymer, can serve to not only provide mechanical stability to maintain the desired shape of the inner curved surface of the multi-layer structure 800, but also provide thermal isolation to protect a user from discomfort and/or harm resulting from excessive heat present at the outer curved surface of the multi-layer structure 800.

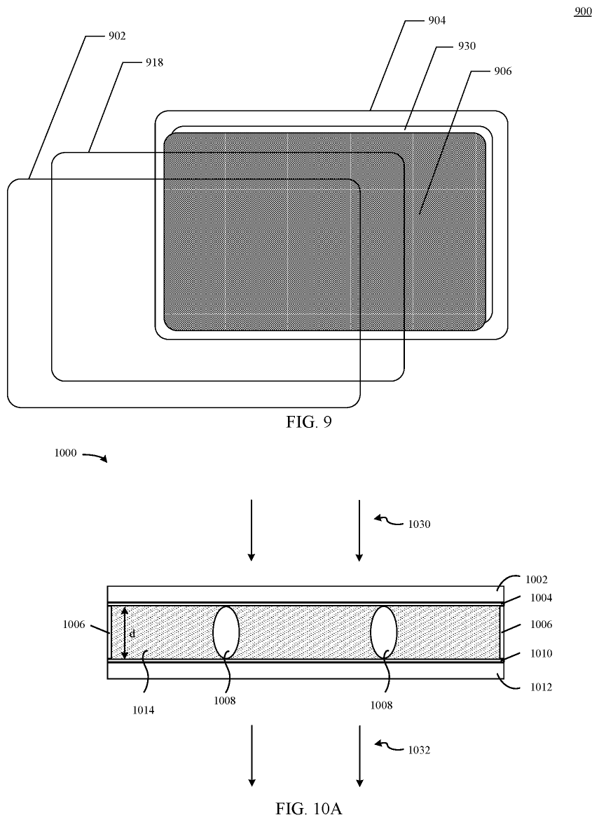

FIG. 9 is a top-down view of a multi-layer structure 900 providing a dimmable window operation with a first rigid substrate 902, a second rigid substrate 904, and a laminate layer 918 between the first rigid substrate 902 and the second rigid substrate 904, according to certain embodiments of the disclosure. The multi-layer structure 900 may be an example of the multi-layer structure 800 shown in FIG. 8. The multi-layer structure 900 may comprise a first rigid substrate 902, a second rigid substrate 904, and a liquid crystal (LC) film positioned between the first rigid substrate 902 and the second rigid substrate 904. A laminate layer 918 bonds the first rigid substrate 902 to the LC film 906 and the second rigid substrate 904. In this example, the LC film 906 is bonded to the second rigid substrate 904 using an optically clear adhesive (OCA) film 930.

Notably, the LC film 906 and the OCA film 930 both have a smaller coverage area than either the first rigid substrate 702 or the second rigid substrate 704. Thus, the LC film 906 and the OCA film 930 only span the inner region of the multi-layer structure 900. By contrast, each of the first rigid substrate 902, the laminate layer 918, and the second rigid substrate 90 spans both the inner region and the perimeter region of the multi-layer structure 900. By sizing the LC film 906 according to a smaller coverage area and positioning the LC film 906 to coincide with the inner region of the multi-layer structure 900, a perimeter region of the multi-layer structure 900 may be realized that provides an area where the first rigid substrate 902 and the second rigid substrate 904 may be coupled together without interfering with and potentially damaging the LC film 906.

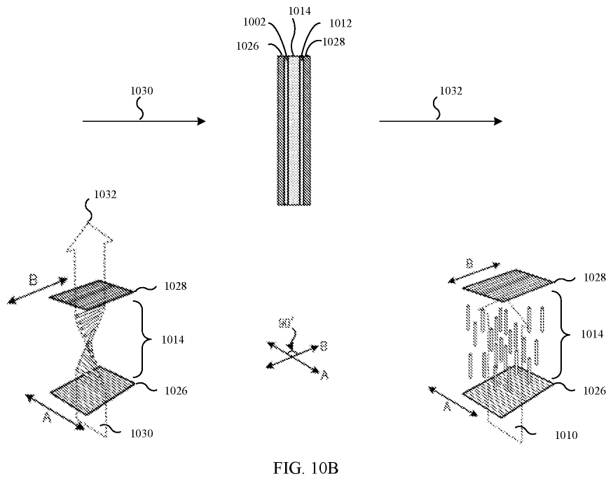

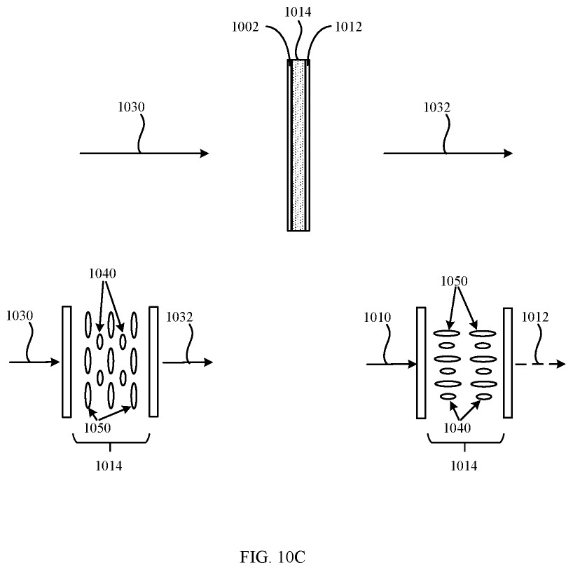

FIG. 10A is a simplified example intended to illustrate components that are typical of an LC film described herein with respect to other embodiments. As used herein, an LC film may also be referred to as an LC assembly. The term “LC assembly” is used in FIGS. 10A-10C, to emphasize that a typical LC film/assembly may have multiple layers and/or components. As will be apparent from the discussion of such other embodiments, an LC assembly can include more or fewer components, or a different arrangement of components. For example, in some embodiments, an LC assembly may include an infrared (IR) filter for blocking IR light and/or an ultraviolet (UV) filter layer for blocking UV light. A UV or IR filter can be beneficial for glare protection as well as protection against overheating due to electromagnetic radiation at wavelengths associated with IR or UV. Similarly, in some embodiments, an LC assembly may include an anti-reflective coating as one or more layers.

As shown in FIG. 10A, the LC assembly 1000 may include a first substrate 1002, a second substrate 1012, and a liquid crystal 1014 disposed between the first substrate 1002 and the second substrate 1012. A first electrode 1004 is disposed between the first substrate 1002 and the liquid crystal 1014, and a second electrode 1010 is disposed between the second substrate 1012 and the liquid crystal 1014. The first electrode 1004 and the second electrode 1010 are configured to provide the voltage or electric field to the liquid crystal 1014. A sealant 1006 is provided between the first substrate 1002 and the second substrate 1012 to bond the first substrate 1002 and the second substrate 1012, and to separate the liquid crystal 1014 for the exterior environment. Spacers 1008 are positioned among the liquid crystal 1014 to support the first substrate 1002 and the second substrate 1012. Incoming light 1030 is incident to the first substrate 1002, and exits from the second substrate 1012 as outgoing light 1032.

FIG. 10B illustrates an example configuration of a liquid crystal 1014 to provide adjustable light transmittance. As shown in FIG. 10B, the liquid crystal 1014 can be configured as a twisted nematic (TN) liquid crystal. The liquid crystal particles can be aligned by rubbing patterns to form a twisted, helical structure in the absence of an applied electric field. The helical structure can rotate the polarization axis of polarized light as the polarized light traverses the liquid crystal layer, with the angle of rotation adjustable by an electric field applied across the liquid crystal layer, e.g., an electrical field formed using control signals produced by the control unit. As the polarized light traverses through the liquid crystal layer, the helical structure causes the polarization axis of the polarized light to rotate by a certain angle (e.g., a 90-degree angle) determined by the rubbing patterns. If an electric field is applied, the liquid crystal particles can align in parallel with the electric field. The polarization axis of the polarized light can be maintained and not rotated as the light traverses the aligned liquid crystal particles. Embodiments featuring TN liquid crystal are not limited to configurations that rotate the helical structure by a 90° twist angle. For example, in some implementations, an LC assembly may be configured to rotate the helical structure anywhere from 180° to 270° (a feature of super-twisted nematic (STN) displays). In some implementations, the rotation may be less than 90° (sometimes used to form mixed-mode TN (MTN) displays). Further, TN liquid crystal can include nematic liquid crystal with a chiral dopant that imparts chirality to the nematic liquid crystal. Accordingly, TN liquid crystal can be any liquid crystal that has a twisted structure in a default or voltage-off state, i.e., prior to applying an electric field to “untwist” the liquid crystal particles. Additionally, although FIG. 10B depicts a single rotational direction, an LC assembly can, in some implementations, an LC assembly can have liquid crystal with two or more rotational directions to, for example, permit a different alignment of liquid crystal particles in a first segment than liquid crystal particles in a second segment.

In certain embodiments, a conductive layer corresponding to an electrode may be divided into different regions. For example, the layer corresponding to electrode 1004 and the layer corresponding to electrode 1010 can each be divided into different regions that correspond to segments, which can differ in shape and/or size. The different regions can be formed by chemically or mechanically etching the conductive layer to form etched patterns. The etched patterns are distinct from the above-described rubbing patterns and can be used to form discrete segments or, in the case of an LCD display, discrete pixels (e.g., red, green, or blue sub-pixels). Such segments can be individually dimmable by controlling the liquid crystal alignment in the segments to display stripes, logos, text, or other graphics, with or without the aid of an electrically controllable illumination source such as a backlight. For example, an LC assembly can be configured as a seven-segment display, where dimming different combinations of the seven segments results in display of different numerals. Accordingly, a conductive layer can include multiple pairs of electrodes, where each pair of electrodes corresponds to a different region that is individually controllable through application of a corresponding electrical signal to establish a voltage across the pair of electrodes.

Liquid crystal 1014, as well as first substrate 1002 and second substrate 1012, can be sandwiched between a first polarizer layer 1026 and a second polarizer layer 1028. Alternatively, the polarizer layers 1026, 1028 can be intervening layers between the substrates 1002, 1012 and the liquid crystal 1014. In a normally-white configuration, first polarizer layer 1026 can have a polarization axis A, whereas second polarizer layer 1028 can have a polarization axis B. The two polarization axes can form a 90-degree angle with respect to each other. Incoming light 1030 can become linearly polarized by first polarizer layer 1026. The linearly polarized light can be rotated by liquid crystal 1014 by an angle configured by the TN structure as described above. Maximum light transmittance can be achieved in a case where no electric field is applied. When no electric field is applied, the liquid crystal 1014 rotates the polarization axis of the polarized light to align with the polarization axis B of second polarizer layer 1028. Minimum light transmittance can be achieved when the polarization axis of the polarized light is not rotated, due to application of an electric field, such that the polarization axis of the polarized light becomes perpendicular to the polarization axis B of second polarizer layer 1028. In such a case, the polarized light aligns with the absorption axis of second polarizer layer 1028 and can be absorbed by second polarizer layer 1028 at a maximum absorption rate. The magnitude of the electric field determines the angle of rotation of the polarized light, which can vary the portion of incoming light 1030 that passes through liquid crystal cell 1014 as outgoing light 1032. A typical range of light transmittance achievable by a TN liquid crystal can be between 0.5% to 36%.

TN liquid crystal can provide various advantages compared to other liquid crystal technologies. For example, TN liquid crystal typically has extremely fast response characteristics and can adjust the light transmittance within a very short period of time (e.g., 100 milliseconds or less). TN liquid crystal can also provide good light blocking. For example, the minimum light transmittance of TN liquid crystal can reach as low as 0.1%. Additionally, as a TN liquid crystal does not have suspended particles or a polymer to scatter light, a TN liquid crystal cell may introduce less haze and may improve visibility across a range of light transmittance levels.

Additionally, as discussed above, it can be advantageous to include a flexible substrate in an LC assembly. For example, the first substrate 1002 and/or the second substrate 1012 may comprise a transparent flexible material (e.g., PET or PVB). Accordingly, in some embodiments, a dimmable LC assembly includes: a flexible substrate, a liquid crystal layer including TN liquid crystal, and polarizer layers. Additionally, such an LC assembly can include a rigid transparent layer (e.g., glass or PC) configured to serve as a structural support for the LC assembly and to operate as a window. This rigid transparent layer can be an additional layer laminated together with a substrate (e.g., first substrate 1002 or second substrate 1012), possibly with one or more intervening layers between the rigid transparent layer and the substrate (e.g., a connecting layer that holds the rigid transparent layer and the substrate together). The rigid transparent layer can therefore be formed integrally with the LC assembly. However, it is also possible to manufacture the LC assembly separately so that the LC assembly can later be attached onto a window as a thin film. Optionally, the rigid transparent layer may be curved.

FIG. 10C illustrates another example configuration of liquid crystal 1014 to provide adjustable light transmittance. In FIG. 10C, liquid crystal assembly 1000 does not include the polarizer layers 1026 and 1028. The use of polarizers is unnecessary in the example of FIG. 10C because liquid crystal 1014 can be configured as a Guest-Host (GH) liquid crystal including liquid crystal particles 1040, which act as a host, and dye particles 1050, which act as a guest. Liquid crystal particles 1040 and dye particles 1050 can modulate the light transmittance based on the Guest-Host effect. Specifically, the dye particles 1050 can be configured to absorb light having an electric field that is perpendicular to the long axis of the dye particles.

In FIG. 10C, the rubbing patterns described above in reference to FIG. 10A can have anti-parallel rubbing directions to set the initial orientation of the liquid crystal particles and dye particles based on an operation mode of liquid crystal cell. In a “normally-white” mode where a liquid crystal assembly is in a transparent state when no electric field is applied, the rubbing directions can be configured such that the long axis of the dye particles is parallel with the electric field of incoming light 1030, and the absorption of light by the dye particles can be set at the minimum. When an electric field is applied across liquid crystal particles 1040, the orientation of liquid crystal particles 1040, as well as dye particles 1050, can change accordingly. As a result, the portion of incident light 1030 absorbed by dye particles 1050, and the light transmittance of liquid crystal assembly 1000, can be adjusted by the electric field applied across liquid crystal 1014. On the other hand, in a “normally-dark” mode, the rubbing directions can be configured such that the long axis of the dye particles is perpendicular to the electric field of incoming light 1030, which leads to maximum absorption of light 1030 by the dye particles. The absorption can be reduced by changing the orientation of the dye particles when an electric field is applied across the liquid crystal.

The example configurations shown in FIGS. 10B and 10C are not mutually exclusive. For example, in some implementations, a liquid crystal can be both a TN liquid crystal (having a twisted structure) and a GH liquid crystal (having dye particles).

By omitting polarizers, a GH-based LC assembly can increase the overall achievable light transmittance while providing reasonable light blocking properties. For example, using the Guest-Host effect, the light transmittance range can be between 10% to 80%. Moreover, a GH liquid crystal can also have fast response characteristics and can adjust the light transmittance within a very short period of time. Further, like TN liquid crystal, a GH liquid crystal does not have suspended particles or a polymer medium to scatter the light. Additionally, the color of the dye particles of a GH liquid crystal can be chosen to selectively transmit light of a particular color while blocking other colors.

In some embodiments, an LC assembly can include vertical alignment (VA) liquid crystals. In VA liquid crystals, the liquid crystal particles are homeotropic, meaning they are aligned perpendicular to the substrate surface, in the absence of an applied electrical field. The homeotropic liquid crystal particles can be realigned to be parallel to the substrate surface by applying an electrical field. A VA liquid crystal generally has negative dielectric anisotropy. In some embodiments, the VA liquid crystal in an LC assembly is a dual frequency liquid crystal (DFLC) that has positive dielectric anisotropy at low frequencies and negative dielectric anisotropy at high frequencies, and is referred to as dual VA. VA liquid crystals can also be GH liquid crystals in which dye particles have been introduced.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

In the description of the disclosure, it should be understood that the azimuth or positional relationship indicated by the terms “center”, “length”, “width”, “up”, “down”, “front”, “back”, “left”, “right”, “inside”, “outside”, and the like, is based on the azimuth or positional relationship shown in the drawings, merely to facilitate and simplify the description of this disclosure, and not to indicate or imply that the indicated device or element must have a particular azimuth, be constructed and operated in a particular azimuth, and therefore is not to be construed as limiting the disclosure. Furthermore, the terms “first” and “second” are used for descriptive purposes only and are not to be construed as indicating or implying relative importance or implying the number of indicated technical features. Thus, features defined as “first”, “second” may expressly or implicitly include one or more of said features. In the description of this application, “plurality” means two or more, unless otherwise expressly and specifically defined.

In the description of the disclosure, unless expressly defined and defined otherwise, terms such as “connected with”, “connected to”, “mounted”, “fixed” and the like are to be understood in a broad sense, for example, may be fixedly connected, detachably connected, or as a whole; may be mechanically connected or electrically connected; may be directly connected, indirectly connected through an intermediate medium, connected inside the two elements or interacted between the two elements. It will be appreciated by those of ordinary skill in the art that the foregoing may be understood as a specific meaning within the present application, depending on the specific circumstances.

Having described several embodiments, various modifications, alternative constructions, and equivalents may be used without departing from the scope of the disclosure as defined by the appended claims. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

1. An apparatus having a multi-layer structure for providing a dimmable window operation, wherein the apparatus comprises:
a first rigid substrate;
a second rigid substrate coupled to the first rigid substrate at a perimeter region of the multi-layer structure, to maintain a separation between the first rigid substrate and the second rigid substrate; and
a liquid crystal (LC) film positioned within the separation between the first rigid substrate and the second rigid substrate,
wherein the LC film is coupled to either the first rigid substrate or the second rigid substrate at an inner region of the multi-layer structure to define a gap between the LC film and another one of the first rigid substrate and the second rigid substrate, and
wherein the gap is not occupied by a solid material or a liquid material.

2. The apparatus of claim 1, wherein the LC film is coupled to the first rigid substrate at the inner region of the multi-layer structure, and the gap is defined between the LC film and the second rigid substrate; or the LC film is coupled to the second rigid substrate at the inner region of the multi-layer structure, and the gap is defined between the LC film and the first rigid substrate.

3. The apparatus of claim 1, wherein:
the first rigid substrate defines a convex exterior surface of the multi-layer structure, and
the second rigid substrate defines a concave interior surface of the multi-layer structure.

4. The apparatus of claim 1, wherein the gap is characterized by a separation distance ranges from 0.1 millimeter to 4 millimeters.

5. The apparatus of claim 1, wherein the gap is configured to maintain a vacuum.

6. The apparatus of claim 1, wherein the gap is filled with at least one gas, and the at least one gas comprises argon gas, or an air mixture including nitrogen gas and oxygen gas.

7. The apparatus of claim 1, further comprising a perimeter support member positioned at the perimeter region of the multi-layer structure and configured to couple the first rigid substrate to the second rigid substrate; wherein the first rigid substrate, the second rigid substrate, and the perimeter support member are configured to maintain airtightness of the separation between the first rigid substrate and the second rigid substrate.

8. The apparatus of claim 7, wherein the first rigid substrate comprises a first glass layer, a second glass layer, and a laminate layer between the first glass layer and the second glass layer.

9. The apparatus of claim 8, wherein the laminate layer comprises a polyvinyl butyral (PVB) material.

10. The apparatus of claim 1, wherein the first rigid substrate comprises a tempered glass layer.

11. The apparatus of claim 1, wherein the second rigid substrate comprises a non-glass layer, wherein the non-glass layer comprises a polycarbonate (PC) material.

12. The apparatus of claim 1, wherein:
the multi-layer structure is configured for installation in a vehicle,
the first rigid substrate is configured to face an exterior environment of the vehicle, and
the second rigid substrate is configured to face an interior environment of the vehicle.

13. The apparatus of claim 12, wherein the multi-layer structure is configured as a sunroof, a side window, a rear windshield, or a front windshield of the vehicle.

14. An apparatus having a multi-layer structure for providing a dimmable window operation, the apparatus comprising:
a first rigid substrate;
a second rigid substrate coupled to the first rigid substrate at a perimeter region of the multi-layer structure, to maintain a separation between the first rigid substrate and the second rigid substrate;
a liquid crystal (LC) film positioned within the separation between the first rigid substrate and the second rigid substrate; and
a laminate layer positioned between the LC film and the first rigid substrate, wherein:
the LC film spans an inner region of the multi-layer structure and is coupled to the second rigid substrate at the inner region of the multi-layer structure,
the LC film interfaces with the laminate layer at the inner region of the multi-layer structure,
the laminate layer interfaces with the first rigid substrate at both the inner region of the multi-layer structure and the perimeter region of the multi-layer structure, and
the laminate layer interfaces with the second rigid substrate at the perimeter region of the multi-layer structure.

15. The apparatus of claim 14, wherein the laminate layer comprises a solid material or a liquid material.

16. The apparatus of claim 14, wherein the laminate layer comprises a polyvinyl butyral (PVB) material.

17. The apparatus of claim 14, wherein the LC film is coupled, by an optically clear adhesive (OCA) film, to the second rigid substrate at the inner region of the multi-layer structure.

18. The apparatus of claim 14, wherein the second rigid substrate comprises a non-glass layer.

19. The apparatus of claim 18, wherein the non-glass layer comprises a polycarbonate (PC) material.

20. The apparatus of claim 14, wherein:
the first rigid substrate defines a convex exterior surface of the multi-layer structure, and
the second rigid substrate defines a concave interior surface of the multi-layer structure.
